(19) United States
(12) Patent Application Publication
(10) Pub. No.: US 2004/0072066 A1
(43) Pub. Date: Apr. 15, 2004

(54) Lithium metal anode for lithium battery

(75) Inventors: Chung-kun Cho, Kyungki-do (KR); Sang-mock Lee, Kyungki-do (KR); Jong-ki Lee, Seoul (KR); Min-seuk Kim, Seoul (KR)

Correspondence Address: BURNS DOANE SWECKER & MATHIS L L P, POST OFFICE BOX 1404, ALEXANDRIA, VA, 22313-1404, US

(73) Assignee: Samsung SDI Co., Ltd., Kyungki-do (KR)

(21) Appl. No.: 10/389,752

(22) Filed: Mar. 18, 2003

(30) Foreign Application Priority Data
Oct. 12, 2002 (KR) 2002-62256

(51) Int. Cl. H01M 2/16; H01M 2/18; H01M 4/40; H01M 10/04

(52) U.S. Cl. 429/137; 429/231.95; 429/246; 29/623.2

(57) ABSTRACT

Provided is a lithium metal anode having a lithium metal layer and a porous polymer film integrated with a surface of the lithium metal layer. The lithium metal anode further includes a current collector attached to the surface of the lithium metal layer opposite the porous polymer film. The lithium metal anode further includes a protective coating layer between the porous polymer film and the lithium metal layer, the protective coating layer having lithium ionic conductivity and impermeable to an electrolyte.

### BACKGROUND OF THE INVENTION

This application claims priority from Korean Patent Application No. 2002-62256, filed on Oct. 12, 2002, in the Korean Intellectual Property Office, the disclosure of which is incorporated herein in its entirety by reference.

1. Field of the Invention

The present invention relates to a lithium battery, and more particularly, to a lithium anode for a lithium battery.

2. Description of the Related Art

Lithium metal which can be used for an anode of a lithium battery has a theoretical energy density of about 3860 mAh/g or about 2045 mAh/cm³. Such an energy density is about ten times greater than the energy density of carbon which is generally used as an anode active material.

Since lithium metal is very soft and can be easily extended even by an application of a weak force, a single lithium layer to be rolled as an anode of a lithium battery is required to have a thickness of at least about 50 μm. A greater thickness of the lithium metal layer results in a lower energy density, and the use of a larger amount of lithium leads to a higher explosion risk. For these reasons, a lithium metal layer having an appropriate thickness is combined with a polymeric film such as a polyethyleneterephthalate film or a metallic foil substrate formed of, for example, copper or stainless steel, through deposition or calendaring processes.

In a secondary lithium battery using a lithium metal anode, the repeated charging-discharging cycles lead to the growth of dendrites on the lithium metal anode, which causes internal shorting out of the battery. Moreover, the formation of mossy dead lithium on the anode reduces the capacity of the lithium metal anode. The formation of dendrites and/or dead lithium on a lithium metal anode during repeated charging-discharging cycles is known to be caused mainly by the interaction between the lithium metal and an electrolyte. In this regard, many attempts to solve these problems have been tried in a variety of aspects in the field. However, a secondary lithium battery having a long cycle life span has not been developed with such a lithium metal anode.

### SUMMARY OF THE INVENTION

Accordingly, the invention provides a lithium metal anode for a secondary lithium battery.

The invention also provides a lithium secondary battery with improved life-span by employing the lithium metal anode.

In one aspect, the invention provides a lithium metal anode comprising a lithium metal layer and a porous polymer film integrated with a surface of the lithium metal layer.

In another aspect, the invention provides a lithium battery comprising: a cathode including an active material layer capable of intercalating and de-intercalating lithium ions and susceptible to reversible reaction with lithium; an electrolyte having lithium ionic conductivity; and the above lithium metal anode.

### DETAILED DESCRIPTION OF THE INVENTION

A lithium metal anode according to an embodiment of the present invention includes a lithium metal layer and a porous polymer film integrated with a surface of the lithium metal layer.

Suitable materials for the porous polymer film include, for example, polyethylene and polypropylene. The porous polymer film may have a multi-layered structure, for example, a polyethylene/polypropylene bilayer, a polyethylene/polypropylene/polyethylene triple layer, or a polypropylene/polyethylene/polypropylene triple layer. The porous polymer film retains an electrolyte of a lithium salt in an organic solvent in pores thereof.

The lithium metal layer is formed on one surface of the porous polymer film using, for example, vacuum deposition. The thickness of the lithium metal layer is in the range of about 1-100 μm, depending on a desired cell capacity. The lithium metal anode according to the present invention may further comprises a current collector attached to the surface of the lithium metal layer opposite the porous polymer layer. In this case, the current collector may contain nickel or copper. The current collector may be formed on the lithium metal layer using, for example, vacuum deposition, sputtering, etc. In an embodiment, a thin film type current collector, instead of a conventional foil type current collector, may be used to further enhance the energy density of the battery.

The lithium metal anode according to the present invention may further comprise a protective coating layer between the porous polymer film and the lithium metal layer, the protective coating layer having lithium ionic conductivity and impermeable to the electrolyte.

In an embodiment according to the present invention, the protective coating layer may be an organic material layer. The organic material layer requires a thermal stability strong enough to resist heat generated during vacuum deposition, for example, resistant up to a temperature of 50° C. However, the thermal stability requirement depends on the cooling efficiency of the processing facilities. The organic material layer requires electrochemical stability, ionic conductivity, and insolubility in electrolyte.

The organic material layer contains a polymer, for example, polyacrylate, polyethylene oxide, polysiloxane, polyphosphagen, polytetrafluoroethylene, polyvinylidene fluoride, a vinylidene fluoride-hexafluoropropylene copolymer, a tetrafluoroethyelene-hexafluoropropylene copolymer, polychlorofluoroethylene, a perfluoroalkoxy copolymer, polyfluorocyclic ether, polyacrylonitrile, polymethylmethacrylate, a derivative of the forgoing materials, or a mixture of the forgoing materials. In this case, the organic material layer may be provided with ionic conductivity by the lithium salts migrated from an electrolyte during a later process of battery assembly.

Alternatively, the organic material layer may originally contain both a lithium salt and such an above polymer.

In forming the organic material layer, a dispersion of fine polymeric particles or a polymer solution in which such an above polymer is completely dissolved may be used. However, the polymer solution, rather than the polymer dispersion, is preferred for a higher density organic material layer. Any solvent having a low boiling point, so it can be easily and completely removed after use, may be used to disperse or dissolve the polymer and the lithium salt therein without limitations. Examples of such a solvent include acetonitrile, acetone, tetrahydrofuran, dimethyl formamide, N-methyl pyrrolidinone, etc. Examples of such a lithium salt include lithium perchlorate (LiCIO₄), lithium tetrafluoroborate (LiBF₄), lithium hexafluorophosphate (LiPF₆), lithium triflate (LiCF₃SO₃), lithium trifluoromethanesulfonylamide (LiN(CF₃SO₂)₂, and a mixture of the forgoing salts. A composition containing a polymer, an organic solvent, and/or a lithium salt is applied to one surface of the porous polymer film using, for example, deposition, dipping, coating, spraying, etc., and dried into the organic protective coating layer.

In an embodiment, the organic material layer may be formed of a composition containing an acrylate monomer, a lithium salt, and a polymerization initiator. The composition is applied to one surface of the porous polymer film, for example, using deposition, dipping, coating, spraying, etc., and dried into the organic protective coating layer. Suitable acrylate monomers for the organic material layer include, for example, epoxy acrylate, urethane acrylate, polyester acrylate, silicon acrylate, acrylated amine, glycol acrylate, and mixtures of the forgoing materials, which may be used alone or in combination. The above-listed lithium salts may be used for the composition. Suitable polymerization initiators that are prone to decompose by heat or light and thus generate radicals include, for example, benzophenone, benzoyl peroxide, acetyl peroxide, lauroyl peroxide, dibutyltin diacetate, azobisisobutyronitrile, and mixtures of the forgoing materials.

If the thickness of the organic material layer is too small, the surface of the porous polymer film may not be covered entirely due to formation of pin holes. If the thickness of the organic material layer is too large, the internal resistance tends to increase and the energy density tends to decrease. Therefore, it is preferable that the thickness of the organic protective material layer be in the range of, for example, 0.05-5 μm.

In another embodiment of the present invention, the protective coating layer may be an inorganic material layer having lithium ionic conductivity and slightly permeable or impermeable to an electrolyte. Suitable materials for the inorganic material layer include lithium silicates, lithium borates, lithium aluminates, lithium phosphates, lithium phosphorous oxynitrides, lithium silicosulfides, lithium germanosulfides, lithium lanthanum oxides, lithium titanium oxides, lithium borosulfides, lithium aluminosulfides, lithium phosphosulfides, lithium nitrides, and mixtures of the forgoing materials.

The inorganic material layer may be formed on one surface of the porous polymer film, for example, using sputtering, evaporative deposition, chemical vapor deposition, etc.

If the thickness of the inorganic material layer is too small, the surface of the porous polymer film may not be covered entirely due to formation of pin holes. If the thickness of the inorganic material layer is too large, the internal resistance tends to increase and the energy density tends to decrease. Therefore, it is preferable that the thickness of the inorganic protective material layer be in the range of, for example, 0.01-2 μm.

In an alternative embodiment of the present invention, the protective coating layer may have a multi-layered structure including both the organic and inorganic materials as described above. For example, the organic material layer is formed on one surface of the porous polymer film, and the inorganic material layer is formed on the surface of the organic material layer opposite the porous polymer film . The organic material layer fills the pores in the porous polymer film to provide the porous polymer film with smooth surfaces and thus allows the formation of a planar inorganic material layer thereon. Also, the organic material layer suppresses crack generation in the brittle inorganic material layer during battery manufacture and charging-discharging cycle and reduces internal stress generated in the porous polymer film during vacuum deposition. When the organic material layer is formed of a fluorine-containing resin capable of reacting with lithium metal, the fluorine-containing resin acts to suppress further growth of the dendrites by forming a LiF layer having low ionic conductivity through a reaction with the dendric tips grown through the pin holes in the inorganic material layer.

In forming the protective coating layer, the number of organic and inorganic material layers or the order in which the organic and inorganic material layers are deposited may be changed variously within the sprite and scope of the present invention.

After the protective coating layer is formed on one surface of the porous polymer film, the lithium metal layer is formed on the surface of the protective coating layer opposite the porous polymer film, for example, using a method as described above.

In the lithium metal anode according to the present invention, the material layers are tightly and strongly bound together over their entire surfaces rather than just be stacked upon one another.

The lithium metal anode according to the present invention can be applied to primary as well as secondary lithium batteries.

Batteries can be manufactured using the lithium metal anode according to the present invention by a variety of methods. For example, initially, a cathode is manufactured using a general method applied in the production of lithium batteries. Lithium metal composite oxides, transient metal compounds, sulfur compounds, etc., which are capable of intercalating and de-intercalating lithium ions and susceptible to reversible reaction with lithium, may be used for cathode active materials. After the lithium metal anode is manufactured using the method as described above, the cathode and the anode are combined into an electrode assembly by, for example, rolling or stacking. The electrode assembly is placed in a battery case, and an electrolyte of a lithium salt in an organic solvent is injected into the battery case, thereby resulting in a complete lithium battery.

Any lithium salt and organic solvent commonly used in lithium batteries may be used without limitations.

The invention also provides a lithium battery comprising: a cathode including an active material layer capable of intercalating and de-intercalating lithium ions and susceptible to reversible reaction with lithium; an electrolyte having lithium ionic conductivity; and the above lithium metal anode.

The present invention will be described in greater detail with reference to the following examples. The following examples are for illustrative purposes and are not intended to limit the scope of the invention.

### EXAMPLE 1

Lithium metal was deposited on a 25-μm-thick polyethylene film to a thickness of about 1.4 μm to obtain a lithium metal anode integrated with the polymer film.

67% of sulfone by weight (hereinafter, wt %), 11.4 wt % of carbon black, Ketjenblack, and 21.1 wt % of polyethylene oxide were thoroughly mixed together in acetonitrile with stirring. The resulting slurry was deposited on an aluminium current collector which had been coated with carbon, dried, and calendered to yield a cathode having an energy density of about 1 mAh/cm².

LiCF₃SO₃ was added to an organic solvent mixture containing dioxolane, diglyme, sulfolane, and dimethoxyethane in a volume ratio of 5:2:1:2 with a final concentration of 1M in a resulting electrolyte.

A pouch type battery was manufactured using the lithium metal anode, the cathode, and the electrolyte. The cycling efficiency of the pouch type battery was about 63%.

### EXAMPLE 2

Lithium metal was deposited on a 25-μm-thick polyethylene film to a thickness of about 1.4 μm to obtain a lithium metal anode integrated with the polymer film. Copper was deposited as a current collector on a surface of the lithium metal anode opposite the polymer film.

A pouch type battery was manufactured using the lithium metal anode, and the cathode and electrolyte, which were the same as used in example 1. The cycling efficiency of the pouch type battery was about 70%.

### EXAMPLE 3

A 25-μm-thick polyethylene film was coated with a polyethylene oxide solution to form an organic protective coating layer. The polyethylene oxide solution was prepared by thoroughly mixing and dissolving 0.2 g of polyethylene oxide in 9.8 g of acetonitrile. The organic protective coating layer was coated by dipping the polymer film into the polyethylene oxide solution and dried at room temperature for 3 hours and at 60° C. for 12 hours so as to fully remove acetonitrile. Next, lithium metal was deposited on the organic protective coating layer to a thickness of about 1.4 μm to obtain a lithium metal anode as a stack of the polyethylene film, the organic protective coating layer, and the lithium metal layer.

A pouch type battery was manufactured using the lithium metal anode, and the cathode and electrolyte, which were the same as used in example 1. The cycling efficiency of the pouch type battery was about 75%.

### EXAMPLE 4

After deposition of a 0.5-μm-thick lithium metal layer on a 25-μm-thick polyethylene film, nitrogen (N₂) gas was supplied into a chamber up to 0.5 torr and reacted with the lithium metal layer on the polymer film at room temperature to form an inorganic protective coating layer of Li₃N. Next, lithium metal was deposited on the inorganic protective coating layer to a thickness of about 1.4 μm to obtain a lithium metal anode as a stack of the polyethylene film, the inorganic protective coating layer, and the lithium metal layer.

A pouch type battery was manufactured using the lithium metal anode, and the cathode and electrolyte, which were the same as used in example 1. The cycling efficiency of the pouch type battery was about 77%.

When using the lithium metal anode according to the present invention, a lithium metal support base, such as a current collector layer, is not essentially required for constructing a battery.

Where a lithium metal anode further including a current collector layer is used, since the lithium metal anode is strongly bound to the porous polymer film over their entire surfaces and supported further by the current collector layer, it becomes easier and more convenient to handle and manufacture an electrode assembly in the production of batteries, and the current density becomes more uniform. Moreover, according to the present invention, the current collector layer may be formed thinner than a conventional foil type current collector layer, thereby improving the energy density of the batteries.

Where a lithium metal anode further comprising a protective coating layer is used, the protective coating layer interposed between the polymer film and the lithium metal layer protects the lithium metal layer from direct contact with the electrolyte and suppresses interactions between the lithium metal and the electrolyte. Therefore, in addition to the above-described advantages of the present invention, the cycle life of secondary lithium batteries can be extended.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A lithium metal anode comprising a lithium metal layer and a porous polymer film integrated with a surface of the lithium metal layer.

2. The lithium metal anode of claim 1, wherein the porous polymer film is formed of polyethylene or polypropylene.

3. The lithium metal anode of claim 1, further comprising a current collector attached to the surface of the lithium metal layer opposite the porous polymer film.

4. The lithium metal anode of claim 3, wherein the current collector contains nickel or copper.

5. The lithium metal anode of claim 1, further comprising a protective coating layer between the porous polymer film and the lithium metal layer, the protective coating layer having lithium ionic conductivity and impermeable to an electrolyte.

6. The lithium metal anode of claim 5, wherein the protective coating layer is an organic material layer.

7. The lithium metal anode of claim 6, wherein the organic material layer comprises a polymer selected from the group consisting of polyacrylate, polyethylene oxide, polysiloxane, polyphosphagen, polytetrafluoroethylene, polyvinylidene fluoride, a vinylidene fluoride-hexafluoropropylene copolymer, a tetrafluoroethyelene-hexafluoropropylene copolymer, polychlorofluoroethylene, a perfluoroalkoxy copolymer, polyfluorocyclic ether, polyacrylonitrile, polymethylmethacrylate, derivatives of the forgoing materials, and mixtures of the forgoing materials.

8. The lithium metal anode of claim 7, wherein the organic material layer further comprises a lithium salt.

9. The lithium metal anode of claim 5, wherein the protective material layer is an inorganic material layer.

10. The lithium metal anode of claim 9, wherein the inorganic material layer comprises a material selected from the group consisting of lithium silicates, lithium borates, lithium aluminates, lithium phosphates, lithium phosphorous oxynitrides, lithium silicosulfides, lithium germanosulfides, lithium lanthanum oxides, lithium titanium oxides, lithium borosulfides, lithium aluminosulfides, lithium phosphosulfides, lithium nitrides, and mixtures of the forgoing materials.

11. The lithium metal anode of claim 5, wherein the protective coating layer comprises both an organic material layer and an inorganic material layer.

12. A method for manufacturing a lithium battery, the method comprising:
preparing a cathode including an active material layer capable of intercalating and de-intercalating lithium ions and susceptible to reversible reaction with lithium;
preparing the lithium metal anode according to claim 1;
forming an electrode assembly including the cathode and the lithium metal anode; and
placing the electrode assembly and an electrolyte in a battery case and sealing up the battery case.

13. A lithium battery comprising:
a cathode including an active material layer capable of intercalating and de-intercalating lithium ions and susceptible to reversible reaction with lithium;
an electrolyte having lithium ionic conductivity; and
the lithium metal anode according to claim 1.
